(19) United States
(12) Patent Application Publication
(10) Pub. No.: US 2024/0327960 A1
(43) Pub. Date: Oct. 3, 2024

(54) SOFT MAGNETIC STEEL SHEET AND MANUFACTURING METHOD THEREOF

(71) Applicant: HONDA MOTOR CO., LTD., Tokyo (JP)

(72) Inventors: Yoshiyuki NAKAZAWA, Saitama (JP); Hitoshi ITAMI, Saitama (JP); Akihito NINOMIYA, Saitama (JP); Ryutaro KATO, Saitama (JP)

(21) Appl. No.: 18/439,389

(22) Filed: Feb. 12, 2024

(30) Foreign Application Priority Data
Mar. 30, 2023 (JP) 2023-054834

(51) Int. Cl. C22C 38/02; C21D 6/00; C21D 8/12

(52) U.S. Cl. CPC C22C 38/02; C21D 6/008; C21D 8/1227; C21D 8/1233; C21D 8/1272; C22C 2202/02

(57) ABSTRACT

A soft magnetic steel sheet is manufactured by mixing an amount of molten scrap iron, an amount of substantially pure molten iron and an amount of substantially pure molten silicon so as to produce a molten alloy containing Fe as a base material, 1.0 to 7.0 wt % of Si, and 0.1 to 1.0 wt % of Cu, forming a soft magnetic steel sheet by subjecting the molten alloy to a liquid rapid cooling single roller process, and heat treating the soft magnetic steel sheet in an inert atmosphere at 600 to 1,200° C.

### TECHNICAL FIELD

The present disclosure relates to a soft magnetic steel sheet and a method for manufacturing the same.

### BACKGROUND ART

In recent years, active efforts have been made to significantly reduce waste through preventing creation of, reducing, reusing, and recycling of waste materials. To further promote these efforts, research and development on the recycling of scrap iron are being carried out.

A technology for manufacturing electrical steel sheet (magnetic steel sheet) by using recycled scrap iron (scrap steel) is known in the art. JP6989000B2 discloses a non-oriented magnetic steel sheet having a composition of C: 0.0050 wt % or less, Si: 1.5 to 5.0 wt %, Mn: 0.2 to 3.0 wt %, sol. Al: 0.0030 wt % or less, P: 0.2 wt % or less, S: 0.0050 wt % or less, N: 0.0040 wt % or less, T. Ca; 0.0010 to 0.0080 wt %, T. O: 0.0100 wt % or less REM: 0.0001 to 0.0050 wt %, and a balance consisting of Fe and inevitable impurities.

According to this prior art disclosed in JP6989000B2, the magnetic steel sheet is produced by hot rolling cast steel slab and cold rolling the hot rolled steel. According to such a production process, the various impurities in the material have to be kept below prescribed levels (the copper in the material is required to be 0.01 wt % or less) to ensure the necessary magnetic property and avoid any issues (such as cracking of the steel sheet during the rolling process) in the production process.

Scrap iron typically contains excessively high levels of impurities for use as a material for soft magnetic steel sheet, as opposed to the regular steel produced from iron ore. Since some of these impurities (such as Cu) cannot be adequately removed by a refining process using an electric furnace or the like, it is difficult to achieve the allowable levels of unavoidable impurities in the raw material for the soft magnetic steel sheet as specified in JP6989000B2. Among the inevitable impurities contained in scrap iron, Cu and Sn are known to adversely affect hot workability by causing precipitation embrittlement at high temperatures and in an oxidizing environment, and this problem is further exacerbated when Cu and Sn are both present. Further, since Ni and Cr harden the steel material, they have an adverse effect on cold workability. In addition, inclusions generated in the crystal structure by these impurities have a negative effect on cold workability and significantly deteriorate magnetic properties due to generation of magnetic domains and pinning of magnetic domain wall movement.

### SUMMARY OF THE INVENTION

In view of such a problem of the prior art, a primary object of the present invention is to provide a soft magnetic steel sheet that can ensure favorable magnetic properties even when the raw material thereof contains impurities which are typically found in scrap iron, and a method for manufacturing the same. The present invention further contributes to an improved utilization of scrap iron.

To achieve such an object, an aspect of the present invention provides a soft magnetic steel sheet, including Fe as a base material, 1.0 to 7.0 wt % of Si, and 0.1 to 1.0 wt % of Cu.

According to this aspect, even when the raw material for the soft magnetic steel sheet contains Cu which is a typical impurity in scrap iron, the steel sheet can be given with favorable magnetic properties. Furthermore, the material is given with a favorable, manufacturability in the sense that the material can be rolled into a desired sheet form without significant difficulty.

In this soft magnetic steel sheet, preferably, the soft magnetic steel sheet further includes 0.01 to 0.5 wt % of Cr, 0.01 to 0.5 wt % of Ni, and 0.01 to 0.3 wt % of Sn, a sum of Cu, Cr, Ni, and Sn contents being 1.2 wt % or less.

According to this aspect, even when Cu, Cr, Ni, and Sn which are commonly found in recycled steel or scrap iron are contained in the raw material as impurities, favorable magnetic properties and manufacturability of the soft magnetic steel sheet can be ensured.

To achieve such an object, another aspect of the present invention provides a method for manufacturing a soft magnetic steel sheet, comprising the steps of obtaining a molten alloy containing Fe as a base material, 1.0 to 7.0 wt % of Si, and 0.1 to 1.0 wt % of Cu from a material containing an amount of scrap iron; forming a soft magnetic steel sheet by subjecting the molten alloy to a liquid rapid cooling single roller process; and heat treating the soft magnetic steel sheet in an inert atmosphere at 600 to 1,200° C.

According to this aspect, by rapidly cooling and solidifying the molten alloy, impurity elements are not segregated in specific parts of the crystal structure, and no inclusions that interfere with domain wall movement are formed so that the soft magnetic steel sheet can attain favorable magnetic properties. In this method, preferably, the material further includes an amount of molten silicon. Thereby, the soft magnetic steel sheet acquires favorable magnetic properties. In this method, preferably, the material further includes an amount of substantially pure molten iron. Thereby, scrap iron can be effectively utilized as a material for soft magnetic steel sheet having favorable magnetic properties and manufacturability.

In this method, preferably, the molten alloy further includes 0.01 to 0.5 wt % of Cr, 0.01 to 0.5 wt % of Ni, and 0.01 to 0.3 wt % of Sn, a sum of Cu, Cr, Ni, and Sn contents being 1.2 wt % or less.

According to this aspect, even when Cu, Cr, Ni, and Sn which are commonly found in recycled steel or scrap iron are contained in the raw material as impurities, favorable magnetic properties and manufacturability of the soft magnetic steel sheet can be ensured.

In this method, preferably, the soft magnetic steel sheet has a thickness of 0.03 to 0.15 mm, a magnetic flux density B100 of 1.6 T or more, a magnetic orientation B10/B100 of 0.78 or more, and an iron loss W10/400 of 10 W/kg or less.

According to this aspect, a high quality soft magnetic steel sheet can be obtained.

Preferably, this method further comprises the step of warm rolling and/or cold rolling the soft magnetic steel sheet before the heat treating step.

According to this aspect, by performing warm rolling and/or cold rolling, the surface of the formed soft magnetic steel sheet can be made smooth, and the sheet thickness, sheet width, and other characteristics of the soft magnetic steel sheet can be adjusted appropriately. Further, even if impurities derived from scrap iron are contained in the raw material, since the steel sheet is formed by the liquid rapid solidification single roller process, cracks in the steel sheet can be avoided when warm rolling or cold rolling.

The present invention thus provides a soft magnetic steel sheet that can ensure favorable magnetic properties even when the raw material thereof contains impurities which are typically found in scrap iron, and a method for manufacturing the same.

### BRIEF DESCRIPTION OF THE DRAWINGS

FIG. 1 is an explanatory diagram showing an outline of a soft magnetic steel sheet manufacturing device based on a single roller process;

FIG. 2 is a graph showing the relationship between the iron loss and B10/B100 of soft magnetic steel sheets;

FIG. 3 is a graph showing the relationship between the contents of Cu and Sn of soft magnetic steel sheets and the manufacturability thereof;

FIG. 4 is a graph showing the relationship between the Cu content and iron loss W10/400 of soft magnetic steel sheets;

FIG. 5 is a graph showing the relationship between Cu content and B10/B100 of soft magnetic steel sheets;

FIG. 6 is a graph showing the relationship between the content of impurities (the sum of Cu, Cr, Ni, and Sn contents) and iron loss W10/400 of soft magnetic steel sheets;

FIG. 7 is a graph showing the relationship between the content of impurities (the sum of Cu, Cr, Ni, and Sn contents) and B10/B100 of soft magnetic steel sheets;

FIG. 8 is a microscopic photograph of the crystal structure of a soft magnetic steel sheet (Embodiment 13) captured by using an electron microscope;

FIG. 9 is a microscopic photograph of the crystal structure of a soft magnetic steel sheet (Embodiment 14) captured by using an electron microscope; and

FIG. 10 is a microscopic photograph of the crystal structure of a soft magnetic steel sheet (Prior Art 2) captured by using an electron microscope.

### DETAILED DESCRIPTION OF THE PREFERRED EMBODIMENT(S)

The present invention will be described in the following in more detail in terms of concrete embodiments with reference to the appended drawings.

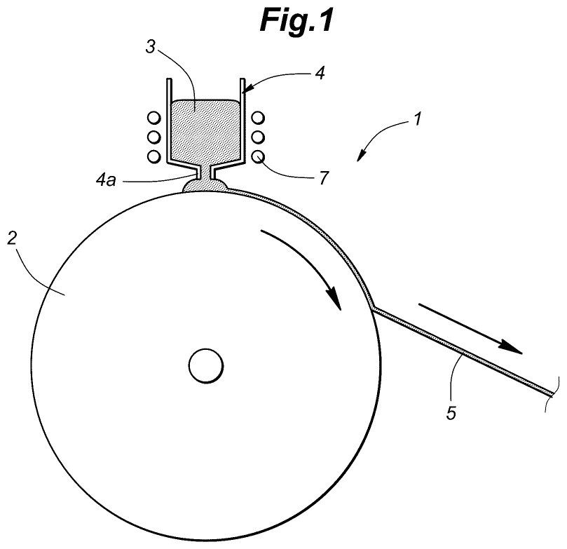

As shown in FIG. 1, the manufacturing device 1 for manufacturing a soft magnetic steel sheet is based on a single roller process (liquid rapid solidification single roller process). The manufacturing device 1 includes a rotating cooling roller 2 and a nozzle 4 that discharges molten metal 3 serving as the raw material for the soft magnetic steel sheet. In particular, the molten metal 3 consists of a molten alloy containing Fe as a base material, 1.0 to 7.0 wt % of Si, and 0.1 to 1.0 wt % of Cu prepared by mixing an amount of molten scrap iron, an amount of substantially pure molten iron and an amount of substantially pure molten silicon.

In this manufacturing device 1, the molten metal 3 is discharged from the injection orifice 4a of the nozzle 4 toward the cooling roller 2 that rotates at a predetermined speed (500 to 2,000 rpm, for example). The discharged molten metal 3 is rapidly cooled on the surface of the cooling roller 2, thereby forming a thin strip 5 along the surface of the cooling roller 2. The thin strip 5 is peeled off from the surface of the cooling roller 2, and continuously wound up by a winding device (not shown in the drawings) so that a coil of the thin strip 5 is formed. This thin strip 5 is suitable for use as a soft magnetic steel sheet typically used as the material for cores of electromagnets of electric motors, transformers and other electromagnetic applications.

The cooling roller 2 has a diameter of 200 mm and an outer peripheral surface made of Cu—Cr alloy or carbon steel. Further, a heater 7 is attached around the nozzle 4 so that the temperature of the molten metal 3 that is discharged from the nozzle 4 is maintained appropriately. Further, the molten metal 3 is discharged from the injection orifice 4a under the pressure of a gas (for example, nitrogen gas) supplied into the nozzle 4.

The coil of the thin strip 5 formed by the manufacturing device 1 is heat treated (annealed) in an inert atmosphere in a heating furnace (not shown in the drawings) (a heat treatment process). An inert atmosphere can be achieved by filling the furnace with an inert gas such as argon gas or helium gas. However, the furnace may also be filled with nitrogen gas, hydrogen gas, or the like. Thereby, a soft magnetic steel sheet having predetermined magnetic properties is obtained. The obtained soft magnetic steel sheet is suitable for use as the material for cores of electromagnets of electric motors, transformers and other electromagnetic applications.

The temperature of the heat treatment may be in the range of 600 to 1,200° C., more preferably in the range of 1,050 to 1,150° C. Further, the time period for the heat treatment may be in a range of 10 seconds to 48 hours, more preferably in a range of 3 to 24 hours. As a result, the internal stress of the thin strip 5 is removed, and an improvement in the structure is achieved so that the magnetic properties (such as iron loss) of the finally obtained soft magnetic steel sheet can be improved.

In manufacturing the soft magnetic steel sheet, optionally, after forming the thin strip 5, warm rolling and/or cold rolling may be performed on the thin strip 5 before heat treatment. The warm rolling may be performed on the thin strip 5 at a temperature in the range of 600 to 900° C. by using, for example, a per se known warm rolling mill. Further, the cold rolling may be performed on the thin strip 5 at room temperature by using a per se known cold rolling mill. By performing warm rolling and/or cold rolling, the surface of the thin strip 5 is made smooth, and the thickness, width, and properties of the finally obtained thin strip 5 (i.e., soft magnetic steel sheet) can be appropriately adjusted.

The raw materials used for manufacturing the soft magnetic steel sheet of this embodiment include scrap steel (scrap iron) which is commercially available in the recycled material market. For example, scrap iron discharged from manufacturing facilities for cars or the like, scrap iron recovered from scrapped cars, etc. may be used as the raw material.

Steel scrap from such sources often contains, in addition to Fe (iron) which is the base material of soft magnetic steel sheet, impurities such as Cu (copper), Cr (chromium), Ni (nickel), Sn (tin), and the like.

From the viewpoint of manufacturing soft magnetic steel sheet in a stable manner and ensuring good magnetic properties, the contents of impurities (i.e., Cu, Cr, Ni, and Sn) are preferably kept within a predetermined range.

The content of Cu in the soft magnetic steel sheet is preferably 0.1 to 1.0 wt %. The content of Cr in the soft magnetic steel sheet is preferably 0.01 to 0.5 wt %. The content of Ni in the soft magnetic steel sheet is preferably 0.01 to 0.5 wt %. The content of Sn in the soft magnetic steel sheet is preferably 0.01 to 0.3 wt %. Further, in the soft magnetic steel sheet, the sum of Cu, Cr, Ni, and Sn contents is preferably 1.2 wt % or less, more preferably 1.0 wt % or less. In addition, since none of these impurities are essential for the soft magnetic steel sheet, the contents of one or more of the impurities may be zero.

If the content of any of these impurities should exceed the upper limit of the desired range, it can be adjusted to be below the allowable range by, for example, selecting the type or source of the scrap iron used as the raw material, and adjusting the amount of pure iron that is added to the material.

In order to reduce iron loss, it is preferable to add Si (silicon) to the raw material as a component that is lacking in common scrap iron. The content of Si in the manufactured soft magnetic steel sheet is preferably 1.0 to 7.0 wt %.

The thickness of the finally obtained soft magnetic steel sheet is preferably 0.03 to 0.15 mm. In addition, the soft magnetic steel sheet is desired to have favorable magnetic properties, such as a magnetic flux density B100 of 1.6 T or more, a magnetic orientation ratio B10/B100 of 0.78 or more, and an iron loss W10/400 of 10 W/kg or less. Here, “magnetic flux density B100” means the magnetic flux density when the magnetic field strength is 10000 A/m, “B10/B100” is the ratio of “B10” to “B100” and is a measure of the degree of magnetic orientation, and “iron loss W10/400” means the iron loss at a frequency of 400 Hz and a magnetic flux density of 1.0 T.

### EMBODIMENTS

As Embodiments 1-19, raw materials were prepared in which the base material consists of Fe and the impurity contents of Cu, Cr, Ni, and Sn are varied from one Embodiment to another, samples of soft magnetic steel sheet were manufactured by using these raw materials, and the manufacturability and magnetic properties of each sample were evaluated.

In manufacturing the soft magnetic steel sheet for each Embodiment 1-19, the raw material containing impurities in the corresponding ratios was prepared. More specifically, pure iron and ferrosilicon are mixed and melted, and various impurities (Cu, Cr, Ni, and Sn) are mixed therein by corresponding amounts to achieve each predetermined chemical composition.

Thereafter, thin strips 5 were formed by using the manufacturing device 1 based on the single roller process (see FIG. 1). More specifically, by discharging the molten metal 3 from the injection orifice 4a of the nozzle 4 onto the outer peripheral surface of a cooling roller 2 and rapidly solidifying the molten metal 3, the thin strips 5 having predetermined thicknesses (see Table 1) and a predetermined width of 20 mm were formed. At this time, the temperature of the molten metal 3 was 1,400 to 1,700° C., the circumferential speed of the cooling roller 2 was 5 to 20 m/s, the discharge pressure of the molten metal 3 was 10 kPa to 40 kPa, and the gap between the tip of the nozzle 4 and the cooling roller 2 was adjusted to be 0.2 mm to 0.4 mm.

Further, the strips 5 were heat-treated in an inert environment (Ar gas) of a heating furnace under predetermined conditions (see Table 1).

In addition, as in Comparison 1-6, soft magnetic steel sheets were manufactured in the same manner as Embodiments 1-19 by using raw materials that do not contain Cu, Cr, Ni, and Sn as impurities by any appreciable amounts. The manufacturability and magnetic properties were evaluated.

Regarding Embodiments 1-19 and Comparisons 1-6, the chemical compositions and heat treatment conditions (temperature, time) are shown in Table 1. In addition, in Table 1, those that could be formed into the thin strip 5 by the manufacturing device 1 are each indicated by a hollow circle (o), and those that could not be formed into the thin strip 5 (those in which cracks developed during the manufacturing process) are each indicated by an x (cross mark). The same applies to Table 2, which will be discussed later.

In addition, soft magnetic steel sheets were manufactured by using a conventional hot rolling process (hereinafter referred to as “Prior Art 1-3”), and manufacturability and magnetic properties thereof were evaluated. In Prior Art 1-3, an ingot whose chemical composition was adjusted in a vacuum melting furnace was hot rolled to a thickness of 2 mm at a temperature of 1,100° C., and then cold rolled to form a steel sheet having a thickness of 0.1 mm. However, in Prior Art 3, cracks occurred during cold rolling so that the forming process was unsuccessful. The obtained steel sheet was heat treated in the same manner as in Embodiments 1-19.

TABLE 1

| | | | | | | | | heat treatment | | |
|---|---|---|---|---|---|---|---|---|---|---|
| | chemical composition [wt %] | | | | | | | temp | time | |
| No. | Si | Fe | Cr | Ni | Cu | Sn | impurities | [° C.] | [h] | manufacturability |
| Embodiment | 1.9 | bal. | 0.20 | 0.10 | 0.40 | 0.02 | 0.72 | 1150 | 24 | ◯ |
| 1 | | | | | | | | | | |
| Embodiment | 3.0 | bal. | 0 | 0 | 0.10 | 0.20 | 0.30 | 1150 | 24 | ◯ |
| 2 | | | | | | | | | | |
| Embodiment | 3.0 | bal. | 0 | 0 | 0.20 | 0.20 | 0.40 | 1150 | 24 | ◯ |
| 3 | | | | | | | | | | |
| Embodiment | 3.0 | bal. | 0.09 | 0.05 | 0.20 | 0.10 | 0.44 | 1150 | 24 | ◯ |
| 4 | | | | | | | | | | |
| Embodiment | 3.0 | bal. | 0 | 0 | 0.50 | 0.20 | 0.70 | 1150 | 24 | ◯ |
| 5 | | | | | | | | | | |
| Embodiment | 3.0 | bal. | 0 | 0.30 | 0.40 | 0.02 | 0.72 | 1150 | 24 | ◯ |
| 6 | | | | | | | | | | |
| Embodiment | 3.0 | bal. | 0.20 | 0.10 | 0.40 | 0.02 | 0.72 | 1050 | 3 | ◯ |
| 7 | | | | | | | | | | |
| Embodiment | 3.0 | bal. | 0.20 | 0.10 | 0.40 | 0.02 | 0.72 | 1050 | 24 | ◯ |
| 8 | | | | | | | | | | |
| Embodiment | 3.0 | bal. | 0.20 | 0.10 | 0.40 | 0.02 | 0.72 | 1150 | 3 | ◯ |
| 9 | | | | | | | | | | |
| Embodiment | 3.0 | bal. | 0.20 | 0.10 | 0.40 | 0.02 | 0.72 | 1150 | 24 | ◯ |
| 10 | | | | | | | | | | |
| Embodiment | 3.0 | bal. | 0.30 | 0.12 | 0.30 | 0.25 | 0.97 | 1150 | 24 | ◯ |
| 11 | | | | | | | | | | |
| Embodiment | 3.0 | bal. | 0 | 0 | 1.00 | 0 | 1.00 | 1150 | 24 | ◯ |
| 12 | | | | | | | | | | |
| Embodiment | 3.0 | bal. | 0 | 0 | 1.00 | 0.20 | 1.20 | 1150 | 24 | ◯ |
| 13 | | | | | | | | | | |
| Embodiment | 3.0 | bal. | 0 | 0 | 1.20 | 0.25 | 1.45 | 1150 | 24 | ◯ |
| 14 | | | | | | | | | | |
| Embodiment | 3.0 | bal. | 0 | 0 | 1.60 | 0.30 | 1.90 | 1150 | 24 | ◯ |
| 15 | | | | | | | | | | |
| Embodiment | 3.0 | bal. | 0 | 0 | 2.10 | 0.50 | 2.60 | 1150 | 24 | ◯ |
| 16 | | | | | | | | | | |
| Embodiment | 3.0 | bal. | 0 | 0 | 3.60 | 0.70 | 4.30 | 1150 | 24 | ◯ |
| 17 | | | | | | | | | | |
| Embodiment | 3.0 | bal. | 0 | 0 | 5.00 | 1.00 | 6.00 | — | — | X |
| 18 | | | | | | | | | | |
| Embodiment | 6.5 | bal. | 0.20 | 0.10 | 0.40 | 0.02 | 0.72 | 1150 | 24 | ◯ |
| 19 | | | | | | | | | | |
| Comparison | 1.9 | bal. | 0 | 0 | 0 | 0 | 0 | 1150 | 24 | ◯ |
| 1 | | | | | | | | | | |
| Comparison | 3.0 | bal. | 0 | 0 | 0 | 0 | 0 | 1050 | 3 | ◯ |
| 2 | | | | | | | | | | |
| Comparison | 3.0 | bal. | 0 | 0 | 0 | 0 | 0 | 1050 | 24 | ◯ |
| 3 | | | | | | | | | | |
| Comparison | 3.0 | bal. | 0 | 0 | 0 | 0 | 0 | 1150 | 3 | ◯ |
| 4 | | | | | | | | | | |
| Comparison | 3.0 | bal. | 0 | 0 | 0 | 0 | 0 | 1150 | 24 | ◯ |
| 5 | | | | | | | | | | |
| Comparison | 6.5 | bal. | 0 | 0 | 0 | 0 | 0 | 1150 | 24 | ◯ |
| 6 | | | | | | | | | | |
| Prior Art 1 | 3.0 | bal. | 0 | 0 | 0 | 0 | 0 | 1150 | 24 | ◯ |
| Prior Art 2 | 3.0 | bal. | 0.10 | 0.10 | 0.10 | 0.10 | 0.40 | 1150 | 24 | ◯ |
| Prior Art 3 | 3.0 | bal. | 0.10 | 0.10 | 0.30 | 0.10 | 0.60 | — | — | X |

Table 2 shows the thicknesses and magnetic properties of the soft magnetic steel sheet samples obtained as Embodiment 1-19 and Comparisons 1-6. In Table 2, “W10/400” indicates the iron loss at a frequency of 400 Hz and a magnetic flux density of 1.0 T. Further, “B10”, “B50”, and “B100” indicate magnetic flux densities at magnetic field strengths of 1000 A/m, 5000 A/m, and 10000 A/m, respectively. Further, “B10/B100” is the ratio of “B10” to “B100” and is a measure of magnetic orientation.

TABLE 2

| | thickness | magnetic properties | | | | | |
|---|---|---|---|---|---|---|---|
| | t | W10/400 | B10 | B50 | B100 | | |
| No. | [mm] | [W/kg] | [T] | [T] | [T] | B10/B100 | manufacturability |
| Embodiment | 0.07 | 8.31 | 1.46 | 1.68 | 1.81 | 0.805 | ◯ |
| 1 | | | | | | | |
| Embodiment | 0.07 | 7.14 | 1.37 | 1.57 | 1.72 | 0.794 | ◯ |
| 2 | | | | | | | |
| Embodiment | 0.07 | 6.86 | 1.37 | 1.57 | 1.72 | 0.797 | ◯ |
| 3 | | | | | | | |
| Embodiment | 0.09 | 6.86 | 1.41 | 1.61 | 1.76 | 0.803 | ◯ |
| 4 | | | | | | | |
| Embodiment | 0.07 | 7.08 | 1.41 | 1.61 | 1.76 | 0.800 | ◯ |
| 5 | | | | | | | |
| Embodiment | 0.07 | 6.45 | 1.49 | 1.69 | 1.82 | 0.822 | ◯ |
| 6 | | | | | | | |
| Embodiment | 0.07 | 8.91 | 1.44 | 1.64 | 1.77 | 0.814 | ◯ |
| 7 | | | | | | | |
| Embodiment | 0.07 | 6.62 | 1.45 | 1.63 | 1.76 | 0.824 | ◯ |
| 8 | | | | | | | |
| Embodiment | 0.07 | 7.90 | 1.44 | 1.64 | 1.77 | 0.814 | ◯ |
| 9 | | | | | | | |
| Embodiment | 0.07 | 6.73 | 1.46 | 1.64 | 1.77 | 0.826 | ◯ |
| 10 | | | | | | | |
| Embodiment | 0.06 | 7.15 | 1.38 | 1.59 | 1.73 | 0.798 | ◯ |
| 11 | | | | | | | |
| Embodiment | 0.08 | 7.83 | 1.42 | 1.63 | 1.75 | 0.808 | ◯ |
| 12 | | | | | | | |
| Embodiment | 0.06 | 7.78 | 1.39 | 1.60 | 1.75 | 0.795 | ◯ |
| 13 | | | | | | | |
| Embodiment | 0.10 | 22.31 | 1.37 | 1.61 | 1.76 | 0.775 | ◯ |
| 14 | | | | | | | |
| Embodiment | 0.09 | 23.18 | 1.36 | 1.60 | 1.74 | 0.783 | ◯ |
| 15 | | | | | | | |
| Embodiment | 0.06 | 31.88 | 1.33 | 1.57 | 1.73 | 0.770 | ◯ |
| 16 | | | | | | | |
| Embodiment | 0.08 | 29.28 | 1.32 | 1.57 | 1.72 | 0.765 | ◯ |
| 17 | | | | | | | |
| Embodiment | 0.08 | — | — | — | — | — | X |
| 18 | | | | | | | |
| Embodiment | 0.07 | 3.64 | 1.40 | 1.58 | 1.68 | 0.834 | ◯ |
| 19 | | | | | | | |
| Comparison | 0.07 | 8.32 | 1.44 | 1.67 | 1.80 | 0.800 | ◯ |
| 1 | | | | | | | |
| Comparison | 0.05 | 8.12 | 1.42 | 1.62 | 1.76 | 0.809 | ◯ |
| 2 | | | | | | | |
| Comparison | 0.07 | 6.39 | 1.46 | 1.65 | 1.78 | 0.819 | ◯ |
| 3 | | | | | | | |
| Comparison | 0.10 | 7.29 | 1.41 | 1.61 | 1.75 | 0.807 | ◯ |
| 4 | | | | | | | |
| Comparison | 0.06 | 6.19 | 1.54 | 1.71 | 1.82 | 0.846 | ◯ |
| 5 | | | | | | | |
| Comparison | 0.07 | 3.55 | 1.39 | 1.57 | 1.71 | 0.813 | ◯ |
| 6 | | | | | | | |
| Prior Art 1 | 0.10 | 9.93 | 1.46 | 1.67 | 1.78 | 0.820 | ◯ |
| Prior Art 2 | 0.10 | 14.30 | 1.38 | 1.62 | 1.77 | 0.780 | ◯ |
| Prior Art 3 | 0.10 | — | — | — | — | — | X |

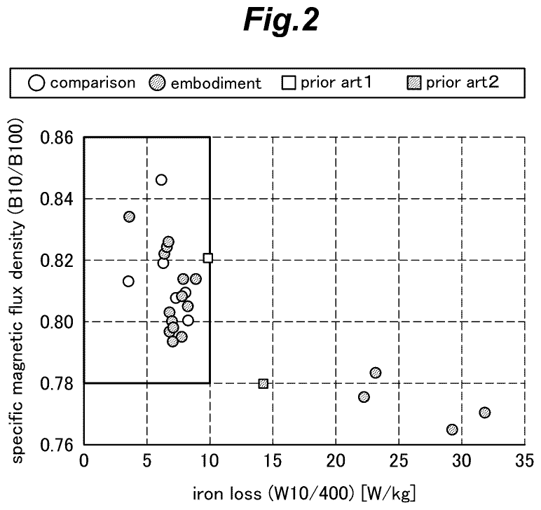

Next, the evaluation results of the magnetic properties of the soft magnetic steel sheets of Embodiments 1-19 and Comparisons 1-6 will be discussed in the following with reference to the graphs of FIGS. 2 to 7 which are based on the data shown in Tables 1 and 2.

FIG. 2 shows the relationship between the iron loss and B10/B100. The iron loss W10/400 of the soft magnetic steel sheet is preferably 10 W/kg or less from the view point of reducing energy consumption. Further, B10/B100 of the soft magnetic steel sheet is preferably 0.78 or more from the viewpoint of ensuring a favorable magnetic orientation.

In Embodiments 14-17 where the Cu content exceeded 1.0 wt %, the iron loss W10/400 exceeded 10 W/kg, and B10/B100 was less than 0.78. Thus, it can be seen that the Cu content of the soft magnetic steel sheet is preferably 1.0 wt % or less from the viewpoint of ensuring good magnetic properties.

In Comparisons 1-6 which did not contain impurities, the iron loss W10/400 of the soft magnetic steel sheet was 10 W/kg or less, and the B10/B100 of the soft magnetic steel sheet was 0.78 or more. Furthermore, in Prior Art 2, the iron loss W10/400 exceeded 10 W/kg, and in Prior Art 3 which contained impurities, soft magnetic steel sheet was not successfully manufactured.

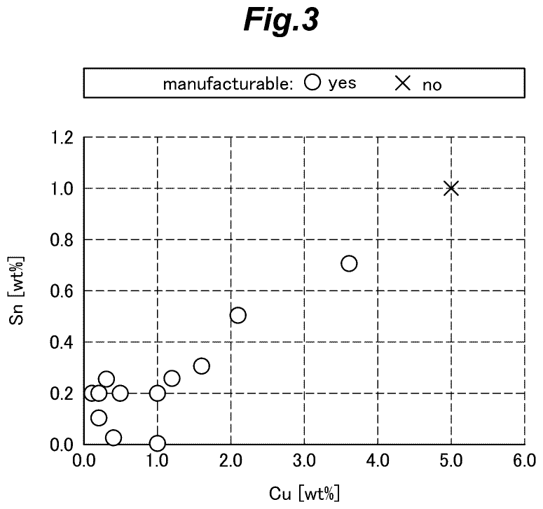

FIG. 3 shows the relationship between the contents of Cu and Sn in a soft magnetic steel sheet and the manufacturability thereof. Regarding Embodiments 1-17 and 19 (i.e., with Cu content in the range of 0.10 to 3.60 wt % and Sn content in the range of 0.1 to 0.70 wt %), soft magnetic steel sheets can be successfully manufactured. On the other hand, regarding Embodiment 18 in which the Cu content was 5.0 wt % and the Sn content was 1.0 wt %, manufacturing a soft magnetic steel sheet was difficult. Thus, the Cu content of the soft magnetic steel sheet is preferably 3.6 wt % or less from the viewpoint of the manufacturability. Similarly, the Sn content of the soft magnetic steel sheet is preferably 0.7 wt % or less.

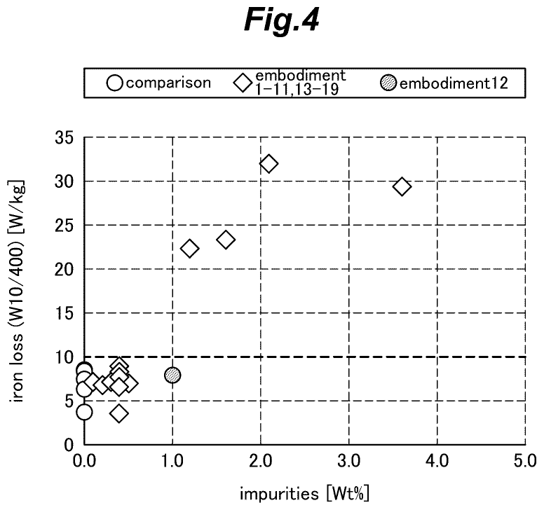

FIG. 4 shows the relationship between the Cu content and the iron loss W10/400 of the soft magnetic steel sheet. Here, Embodiment 12 (see the shaded circle in FIG. 4) contains only Cu as an impurity. In other words, regardless of whether the soft magnetic steel sheet contains only Cu as an impurity or other impurities in addition to Cu, the content of Cu in the soft magnetic steel sheet is desired to be 1.0 wt % or less from the viewpoint of reducing the iron loss W10/400 to 10 W/kg or less. In this case, the content of Cr is preferably 0.3 wt % or less. The Ni content is preferably 0.3 wt % or less. Further, the content of Sn is preferably 0.25 wt % or less.

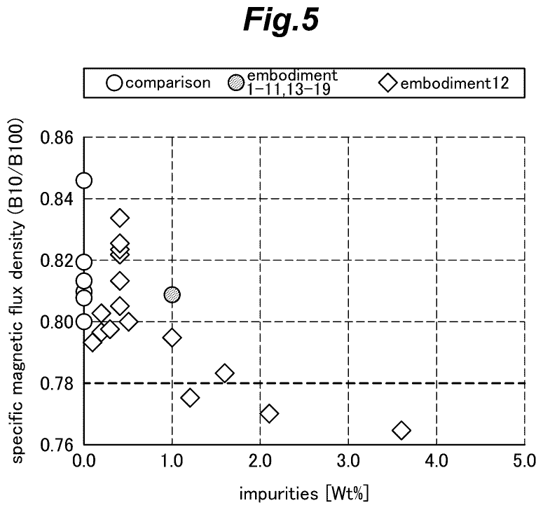

FIG. 5 shows the relationship between the Cu content and B10/B100 of the soft magnetic steel sheet. Here, Embodiment 12 (see the shaded circle in FIG. 4) contains only Cu as an impurity. In other words, regardless of whether the soft magnetic steel sheet contains only Cu as an impurity or other impurities in addition to Cu, the Cu content of the soft magnetic steel sheet is desired to be 1.0 wt % or less from the viewpoint of causing B10/B100 to be 0.78 or more.

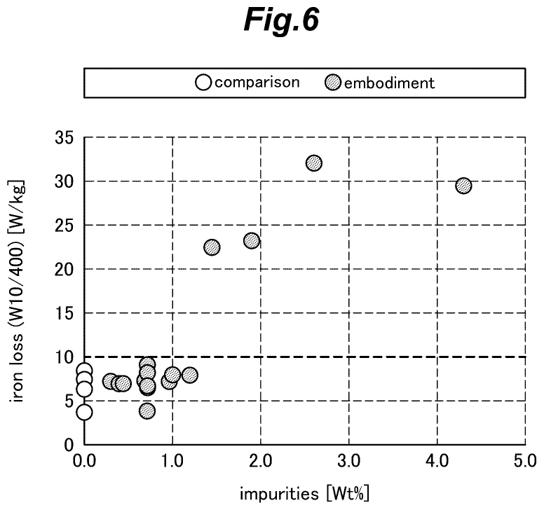

FIG. 6 shows the relationship between the content of impurities (the sum of Cu, Cr, Ni, and Sn contents) and the iron loss W10/400 of the soft magnetic steel sheet. The content of impurities (or the sum of Cu, Cr, Ni, and Sn contents) in the soft magnetic steel sheet is preferably 1.2 wt % or less from the viewpoint of reducing the iron loss W10/400 to 10 W/kg or less.

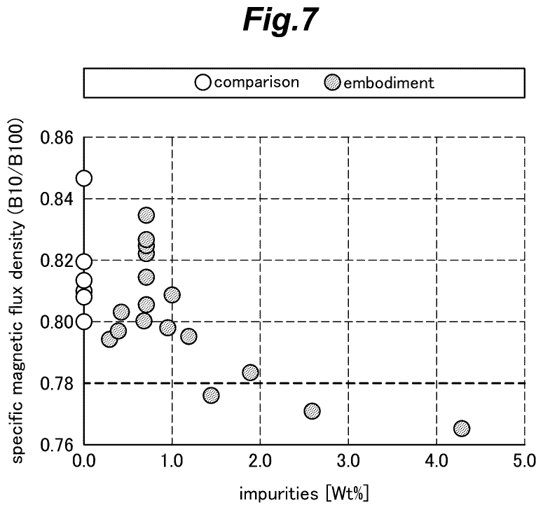

FIG. 7 shows the relationship between the content of impurities (total of Cu, Cr, Ni, and Sn contents) and B10/B100 of the soft magnetic steel sheet. From the viewpoint of setting B10/B100 to be 0.78 or more, the content of impurities (or the sum of Cu, Cr, Ni, and Sn contents) in the soft magnetic steel sheet is preferably 1.2 wt % or less.

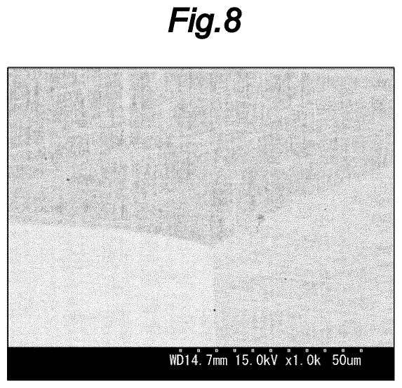

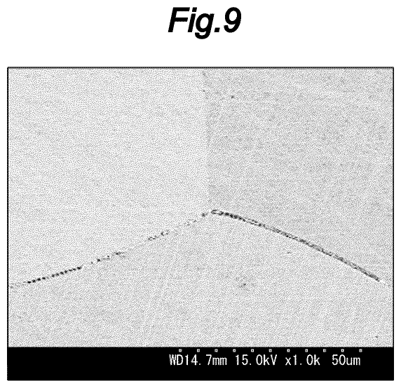

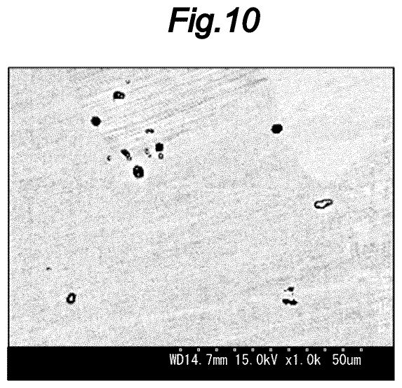

FIGS. 8 to 10 show microscopic photographs of the crystal structures of soft magnetic steel sheets acquired by using a scanning electron microscope (SEM). FIG. 8 shows the crystal structure of Embodiment 13, where no inclusions caused by impurity elements can be observed. On the other hand, in the microscopic photograph of Embodiment 14 (where the Cu content is 1.2 wt %) shown in FIG. 9, inclusions are present at grain boundaries. Also, in the microscopic photograph of Prior Art 2 shown in FIG. 10, inclusions derived from impurity elements are present, and these inclusions deteriorated the magnetic properties thereof.

From the foregoing, it can be seen that the content of Cu in the soft magnetic steel sheet is preferably 1.0 wt % or less from the viewpoint of producing soft magnetic steel sheets in a stable manner from raw materials containing scrap iron and ensuring good magnetic properties (i.e., to achieve magnetic properties equivalent to soft magnetic steel sheets with a low impurity content). Further, the content of Cr is preferably 0.3 wt % or less. The Ni content is preferably 0.3 wt % or less. Moreover, it is preferable that the content of Sn is 0.25 wt % or less. Further, the content of impurities (or the sum of Cu, Cr, Ni, and Sn contents) in the soft magnetic steel sheet is preferably 1.2 wt % or less.

The present invention has been described in terms of specific embodiments thereof, but is not limited by the illustrated embodiments, and can be changed in various ways thereof without departing from the scope of the present invention.

1. A soft magnetic steel sheet, including
Fe as a base material,
1.0 to 7.0 wt % of Si, and
0.1 to 1.0 wt % of Cu.

2. The soft magnetic steel sheet as defined in claim 1, further including
0.01 to 0.5 wt % of Cr,
0.01 to 0.5 wt % of Ni, and
0.01 to 0.3 wt % of Sn,
a sum of Cu, Cr, Ni, and Sn contents being 1.2 wt % or less.

3. A method for manufacturing a soft magnetic steel sheet, comprising the steps of
obtaining a molten alloy containing Fe as a base material, 1.0 to 7.0 wt % of Si, and 0.1 to 1.0 wt % of Cu from a material containing an amount of scrap iron;
forming a soft magnetic steel sheet by subjecting the molten alloy to a liquid rapid cooling single roller process; and
heat treating the soft magnetic steel sheet in an inert atmosphere at 600 to 1,200° C.

4. The method for manufacturing a soft magnetic steel sheet as defined in claim 3, wherein the material further includes an amount of molten silicon.

5. The method for manufacturing a soft magnetic steel sheet as defined in claim 4, wherein the material further includes an amount of substantially pure molten iron.

6. The method for manufacturing a soft magnetic steel sheet as defined in claim 3, wherein the molten alloy further includes 0.01 to 0.5 wt % of Cr, 0.01 to 0.5 wt % of Ni, and 0.01 to 0.3 wt % of Sn, a sum of Cu, Cr, Ni, and Sn contents being 1.2 wt % or less.

7. The method for manufacturing a soft magnetic steel sheet as defined in claim 3, wherein the soft magnetic steel sheet has a thickness of 0.03 to 0.15 mm, a magnetic flux density B100 of 1.6 T or more, a magnetic orientation B10/B100 of 0.78 or more, and an iron loss W10/400 of 10 W/kg or less.

8. The method for manufacturing a soft magnetic steel sheet as defined in claim 6, further comprises the step of warm rolling and/or cold rolling the soft magnetic steel sheet before the heat treating step.
